(19) United States
(12) Patent Application Publication
(10) Pub. No.: US 2019/0315971 A1
(43) Pub. Date: Oct. 17, 2019

(54) CORROSION RESISTANT COMPOSITIONS AND METHODS

(71) Applicant: Vinod C. Malshe, Mumbai (IN)

(72) Inventor: Vinod C. Malshe, Mumbai (IN)

(21) Appl. No.: 16/447,957

(22) Filed: Jun. 20, 2019

Related U.S. Application Data
(63) Continuation of application No. PCT/IN2017/050603, filed on Dec. 19, 2017.

(30) Foreign Application Priority Data
Dec. 20, 2016 (IN) 201621043549

(51) Int. Cl. C09D 5/10; C09D 5/00; C09D 7/61; C09D 7/40; C09D 7/20; C09D 115/00; C09D 167/02; C09D 123/12; C09D 123/06; C09D 177/02; C09D 177/06

(52) U.S. Cl. CPC C09D 5/103; C09D 5/002; C09D 7/61; C09D 7/70; C09D 7/20; C09D 177/06; C09D 167/02; C09D 123/12; C09D 123/06; C09D 177/02; C09D 115/00

(57) ABSTRACT

Coatings for a substrate include a paint or a lacquer and about 0.1% or more particles of a bi-axially oriented metalized polymer film. The film may not be soluble in a solvent or a dispersion medium of the paint or the lacquer. Coatings may be formed by bi-axially orienting a polymer film to obtain a bi-axially oriented polymeric film having thickness of at least 1μ followed by a vacuum metalizing to obtain a bi-axially oriented metalized polymer film, shredding the bi-axially oriented metalized polymer film to form the particles to at least 1×1 mm, selecting a solvent as system or a dispersion medium of paint in which the particles of the polymer film is not substantially soluble, preparing a paint or a coating composition by using selected solvent, and dispersing the shredded particles of oriented metalized polymer film in the paint as a primer, under coat, or top coat.

### RELATED APPLICATIONS

This application claims priority under 35 U.S.C. § 120 to, and is a continuation of, co-pending International Application PCT/IN2017/050603, filed Dec. 19, 2017 and designating the US, which claims priority to Indian Application 201621043549, filed Dec. 20, 2016, such Indian Application also being claimed priority to under 35 U.S.C. § 119. These Indian and International applications are incorporated by reference herein in their entireties.

### BACKGROUND

Corrosion is one of the most serious problems in modern societies. The losses from corrosion each year are hundreds of billions of dollars. Several countries including the United States, United Kingdom, Japan, Australia, Kuwait, Germany, Finland, Sweden, India and China have studied the cost of corrosion. The studies have ranged from formal and extensive efforts to informal and modest efforts. The common finding is that the annual corrosion cost range from 1 to 5% of the gross national product (GNP) of each nation.

Corrosion causes weight loss as well as change of mechanical properties of the substrate to be coated. Rust is one of the most common causes of bridge accidents. Similarly, corrosion of concrete-covered steel and iron can cause the concrete to spall, creating severe structural problems. It is one of the most common failure modes of reinforced concrete bridges. Corrosion of mild steel considerably reduces the useful life of a product. Be it structure, a vessel, a chemical reactor or any other object for which steel is used as a material of construction.

Corrosion is a natural process, which converts a refined metal to a more chemically-stable form, such as its oxide, hydroxide, or sulphide. It is the gradual destruction of materials (usually metals) by chemical and/or electrochemical reaction with the environment. This type of damage typically produces oxide(s) or salt(s) of the original metal, and results in a distinctive orange colouration. Corrosion engineering is the field dedicated to controlling and prohibiting corrosion. Corrosion can also occur in materials other than metals, such as ceramics or polymers, although in this context, the term “degradation” is more common. Corrosion degrades the useful properties of materials and structures including strength, appearance and permeability to liquids and gases. Many structural alloys corrode merely from exposure to moisture in air, but the process can be strongly affected by exposure to certain substances.

Various treatments are used to substantially eliminate corrosion damage to metallic objects which are exposed to the weather, saltwater, acids, or other hostile environments. One of the treatments used to retard corrosion is removal of loosely bound corrosion products that are unstable, surface treatment which ensures complete conversion of intermediate oxides to a more stable state, coverage without gaps, cracks, or pinhole defects. Small defects can act as an “Achilles' heel”, allowing corrosion to penetrate the interior and causing extensive damage even while the outer protective layer remains apparently intact for a period of time. Different forms of common corrosion are uniform corrosion, pitting corrosion or filiform corrosion. Of these pitting and filiform are the most damaging forms of corrosion.

Painting or coatings are employed for number of reasons. Product coatings or industrial coatings are typically applied on a substrates or products, such as appliances, automobiles, aircraft, and the like. Many industries, including the aircraft industry, typically employ coating systems that provide both corrosion protection and enhanced performance. They work by providing a barrier of corrosion-resistant material between the damaging environment and the structural material. Besides cosmetic and manufacturing issues, there may be tradeoffs in mechanical flexibility versus resistance to abrasion and high temperature. Painting or coating either by roller, brush, dipping, spraying, electro deposition, or electroless deposition is more desirable for tight spaces; spray would be better for larger coating areas such as steel decks and waterfront applications.

In order to improve the corrosion resistance of a metal substrate, corrosion inhibitive pigments or additives are typically used in the coatings applied to the substrate. The common corrosion inhibitive pigments are chromates of zinc, barium, strontium or calcium, which provide excellent corrosion resistance. However, in recent years there has been widespread concern over the use of hexavalent chromates, as they are known to be highly toxic and carcinogenic. Furthermore, the disposal of chromate materials is becoming increasingly difficult as municipal and government regulations are becoming more stringent. Efforts to substitute hexavalent chrome-based corrosion inhibitors is an area of intense research and there have been many candidates. Most important of them is zinc phosphate. The main draw back is the requirement of very high concentration due to its poor water solubility (less than 1 ppm) in the coating that makes it uneconomical. Also, the performance of zinc phosphate is far from desirable, primarily due to its very low solubility in water (less than 1 mg per litre). Other proposed materials such as molybdenum and tungsten silico phosphates have not been able to make much of dent and the space for a good replacement of hexavalent chrome pigments is largely vacant.

Generally, there are two mechanisms to prevent corrosion of metals used in construction field:
1. Prevent the ingress of corrosive materials through the film. (water, oxygen, hydrogen sulphide, acidic vapors, carbon dioxide, corrosive ions such as chlorides and bromides); and
2. Release a passivity imparting material through the transmitted liquid or water to protect the surface. (chromates, zinc ions, phosphate ions, molybdenum, tungsten, alkaline earth metal hydroxides like calcium, strontium and barium).

Since the environmental regulations have pushed hexavalent chromium from coatings to near extinction, metal flakes, glass flakes, micaceous iron oxide, mica, etc. have slowly taken the stage. Amongst these, glass flakes are more common with high performance coatings and are generally restricted because of their high cost and high density. Efforts are on to manufacture glass flakes in finer and finer thicknesses. Current industry standard is 10 microns. Finer flakes are available in smaller quantities. Micaceous iron oxide is not readily available in all parts of the world. Synthetic substitutes have worked out very expensive due to very high temperature processing. Besides, during manufacture, the flakes tend to break down and the particles become too fine. If the length and breadth are not several orders of magnitude larger than the thickness, the effectiveness of the pigment as a flake pigment is lost.

The second variety, release of corrosion protecting ions, has now been widely accepted. Zinc phosphate has found recognition in various international standards. A very large concentration of zinc phosphate is recommended by most international specifications. In the applicant's view, it is a waste. The general observation of the coating chemist is, the zinc phosphate has to be there in the formulation because of the specification but for providing corrosion protection he has to use his own skills. It is so because solubility of zinc phosphate in the water medium is very low. (one part per million). Thus, the quantity of zinc or phosphate reaching the substrate undergoing corrosion is inadequate to protect the surface.

Alternate method of prevention of corrosion is the application of metal powder coatings also called as sacrificial corrosion protection. In general, a metal lower in the Galvanic series would be able to protect a metal higher than it. Thus zinc is able to protect iron, magnesium is able to protect aluminium and so on. Coatings based on aluminium metal, zinc metal, and magnesium metal are commonly used for protecting mild steel and aluminium respectively. Metal powders of stainless steel and titanium are able to impart their own properties to the surface when applied in the form of surface coatings.

Flexible polyurethane coatings, like Durabak-M26 for example, can provide an anti-corrosive seal with a highly durable slip resistant membrane. Painting or coatings are relatively easy to apply and have fast drying time although temperature and humidity may cause dry time to vary. Silicone epoxy hybrid resins are able to produce excellent corrosion resistant coatings used in marine environment. Fluoro polymers, fluorinated polymers, poly vinylidene chloride and poly vinylidene fluoride are known for their low permeability and have been used in coating application for corrosion protection. All these polymers have continued to be expensive, either due to their limited market or due to high manufacturing cost.

Protection of corrodible metals is achieved by surface treatment by applying painting or coating on the surface of the substrate. The main function of the coating is to reduce permeation of oxygen and water through the film and thus eliminating contact of either oxygen or water with the substrate. Thus, corrosion of metals such as mild steel does not take place if any one of the two, oxygen or water does not reach the surface. The present days efforts are to reduce the permeability of the coating film. It is achieved by following methods:
Polymer Engineering: By reducing side chains in the polymer to get better packing between molecular chains that do not allow permeability of oxygen and/or water;
Addition of impervious materials such as thin glass flakes (to the tune of 5 to 7%), to reduce permeability of gases. The thickness of the glass flakes is about 5 to 10 microns. Due to high density of glass, a large quantity of glass is required;
Addition of flaky minerals such as micaceous iron oxide. The mineral is scarce. It has very high density (5.6 g/cc). Therefore a large quantity is required; and
Metal powders such as aluminum in flake form, zinc dust, stainless steel, titanium, chromium and nickel as flakes are also suggested in literature. It is very expensive to flatten the particles of these metals because these are very hard and are less malleable. Except aluminum, all metals have high density and relatively large quantities of metals are required to provide reduced permeability. Aluminum metal has very poor corrosion resistance.

As a result, there have been attempts to produce corrosion resistant coatings by using environmentally acceptable corrosion inhibitive additives. However, these coatings are problematic as some of the pigments or additives used are either not compatible with the paint/coat or cause the paint or coat to peel off the substrate. Some are actually known to accelerate the corrosion process.

It is recognized that bi-axial orientation of highly linear polymers reduces the free volume of the polymer and as a result increases the degree of packing within the polymer. The result is, increase in density of the polymer and reduction in permeability of water, nitrogen, oxygen and carbon dioxide. The only known method for orientation of polymers is stretching, preferably bi-axially, so that the molecules of the polymer are aligned in the direction of stretch. The result of stretching is elongation in the direction of stretch and thinning of the substrate, proportionate to the increase in other dimensions. (Increase in length and width may be three to five times for complete orientation, thus the area of the film may increase 15 to 20 times and the thickness may be proportionately reduced). Increase in density partially compensates the extension in both directions. Since all protective paints are applied as a solution, it is not possible to orient the film of the coating because if the film is stretched, it would lose the adhesion to the substrate and the protective qualities are lost.

### SUMMARY

Example embodiments include coatings having a paint or a lacquer and about 0.1% or more particles of a bi-axially oriented metalized polymer film. The film may not be soluble in a solvent or a dispersion medium of the paint or the lacquer. Example embodiment may be formed by bi-axially orienting a polymer film to obtain a bi-axially oriented polymeric film having thickness of at least 1μ followed by a vacuum metalizing to obtain a bi-axially oriented metalized polymer film, shredding the bi-axially oriented metalized polymer film to form the particles to at least 1×1 mm, selecting a solvent as system or a dispersion medium of paint in which the particles of the polymer film is not substantially soluble, preparing a paint or a coating composition by using selected solvent, and dispersing the shredded particles of oriented metalized polymer film in the paint as a primer, an under coat, or a top coat.

### DETAILED DESCRIPTION

Because this is a patent document, general, broad rules of construction should be applied when reading it. Everything described and shown in this document is an example of subject matter falling within the scope of the claims, appended below. Any specific structural and functional details disclosed herein are merely for purposes of describing how to make and use examples. Several different embodiments and methods not specifically disclosed herein may fall within the claim scope; as such, the claims may be embodied in many alternate forms and should not be construed as limited to only examples set forth herein.

It will be understood that, although the ordinal terms “first,” “second,” etc. may be used herein to describe various elements, these elements should not be limited to any order by these terms. These terms are used only to distinguish one element from another; where there are “second” or higher ordinals, there merely must be that many number of elements, without necessarily any difference or other relationship. For example, a first element could be termed a second element, and, similarly, a second element could be termed a first element, without departing from the scope of example embodiments or methods. As used herein, the term “and/or” includes all combinations of one or more of the associated listed items. The use of “etc.” is defined as “et cetera” and indicates the inclusion of all other elements belonging to the same group of the preceding items, in any “and/or” combination(s).

It will be understood that when an element is referred to as being “connected,” “coupled,” “mated,” “attached,” “fixed,” etc. to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to the same previously-introduced term. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof.

As used herein, the term “substrate” refers to a structure having a surface that can be cleaned and/or protected and/or modified to provide corrosion resistance and barrier properties. “Substrate” is not limited to any particular type of material, despite some example embodiments using metal substrates. Corrosion-inhibiting coatings can also be applied to other substrates, such as a polymeric substrate, for example, a coated metallic substrate.

As used herein, the terms “coating” and “painting” are interchangeable. As used herein, the term “coating” refers to an organic or inorganic polymeric material that can be applied as liquid (e.g., paint) and/or solid (e.g., powder) to a substrate to form a polymeric film. Example polymeric materials include powder coatings, paints, sealants, conducting polymers, sol gels, etc. A “coating” includes a mixture of binders, solvents, pigments and/or additives. Coatings may have one or more substances from each of the four categories. Some coating properties, such as gloss and colour, are related to the film surface, i.e., as a two-dimensional entity. Other bulk properties of a coating are related to its three-dimensional structure. Phase continuity is a volume concept, and the coating performance is dependent on the integrity of the binder phase.

As used herein, the term “not substantially soluble” refers to a solubility level of less than about one (1) mmol/L. As used herein, the term “weight percent” (wt %) when used without qualification, refers to the weight percent of a particular solid component, e.g., pigment, extender, etc., compared with all solid components present, excluding polymeric resins and solvents.

As used herein, the terms “paint formulation” and “coating composition” refer to a list of ingredients and/or components and/or a list of instructions for preparing and mixing together the ingredients and/or components to make the same. As used herein, the term “curing” refer to evaporation of solvent. The term includes drying or curing either naturally or by accelerated means for example, an ultraviolet light cured system to form a film or cured paint.

The structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

The Inventor has newly recognized that there is a need to provide corrosion resistant coatings that are effective, yet not based on chromates. Corrosion of a substrate may be reduced by reducing the permeability of water and oxygen. While a coating with particles of bi-axially fully-oriented metalized film may provide the same, the Inventor has recognized that the film should not be soluble, swollen, or otherwise affected by the solvent system. Example embodiments described below address these and other problems recognized by Inventor with unique solutions enabled by example embodiments.

The present invention is corrosion-resistant coating compositions, substrates treated with the same, and methods of forming the same. In contrast to the present invention, the few examples discussed below illustrate just a subset of the variety of different configurations that can be used as and/or in connection with the present invention.

Example embodiment coatings have excellent corrosion resistance performance, while maintaining acceptable levels of paint adhesion properties. Coating compositions are useful in many industries, including, but not limited to, the shipping, aerospace and aircraft industries.

Highly-oriented films from linear film forming polymers produce films with very low permeability for different gases. They may have high barrier properties and be useable in packaging of industrial and food products. Orientation of films involves stretching the film in two directions. It may be in the form of continuous films or even bottles that are formed by blowing a heated pre-form. The bi-axial orientation of polymers results in increased density due to better packing of the molecules and the permeation properties of the product improve 15- to 20-fold. In some cases, these films are still left with permeability. To reduce it further, the films may be metalized with metals such as aluminum, copper, chromium, palladium, and/or platinum. When the contents are corrosive or the diffusivity of the gases is high (due to their solubility in the polymer), the surface may be coated with diamond-like films. Reduction in permeability may also be achieved by coating these surfaces by continuous diamond like films, called diamond like coatings (DLC) of thickness of the order of few angstroms, which make internally-coated bottles suitable for packaging of carbonated beverages and beer, which are otherwise stored in completely impervious glass bottles.

The polymers used may be polyethylene terephthalate, polyamide, polyimide, polystyrene, polysulfone, polyethylene, and/or polypropylene, and the metal coating may be aluminum. To prevent corrosion of aluminum, the metalized surface may be further coated with low-thickness of lacquer. In view of the properties of the oriented polymer films metalized with corrosion resistant metals a paint chemist wishes these properties could be attained in a coating film. The same is not possible because the polymer films need stretching several folds in two directions; that is, directions substantially perpendicular, nearing or at 90°, to each other, referred to as bi-axial orientation. In this process, the length and breadth of the film increase three to five times and thickness reduces. Several properties change as a result of orientation. Permeability is one major such property. Metallization is used to further reduce the permeability.

In an example embodiment, there is provided a corrosion-resistant coating composition including particles of bi-axially oriented metalized polymer film along with paint and other additives. The film should not be soluble in the solvent or dispersion medium of the paint. The composition optionally includes a lacquer.

The coating composition may include at least 0.1% of the particles of a bi-axially oriented metalized polymer film along with a paint or a lacquer and other additives. For example, the coating composition may include 0.1 to 10% of the particles of the bi-axially oriented metalized polymer film along with the paint or the lacquer and other additives.

The oriented metalized polymer film may have low thickness of at least 1μ. For example, thickness of the oriented metalized polymer film may be in the range of 1 to 200μ, such as 1 to 5μ. The particles of the oriented metalized polymer film have dimensions of at least 1×1 mm. For example, dimension of the particles of the oriented metalized polymer film may be in the range of 1 to 6 mm×1 to 6 mm, such as 1×1 mm to 2×2 mm. The metalized film particles (L×B×T=1-1.2 mmλ1-1.2 mm X=1 to 30 microns (0.001 to 0.03 mm) have been used as decorative materials for various objects where no protection is intended. Their concentration is rather low (1-2 g per litre).

The particles of the oriented metalized polymer film are added in the range of at least equivalent to two times the surface area required to be coated. For example, the particles of the oriented metalized polymer film may be added in the range of at least twice to four times surface area required to be coated, so that there is adequate overlap of the films and no part of the coating is deficient in the oriented film.

The polymer may be selected from polyethylene terephthalate; aliphatic or aromatic polyamides; aliphatic or aromatic polyimides; polysulfones; polypropylene; high, low or medium density polyethylene; linear low density polyethylene; polystyrene; polyvinyl chloride; polyvinylidene chloride; PVDF; PTFE; etc.

The polymer may be bi-axially oriented and further metalized with or without vacuum or electro deposition, or electroless coating. The metal used for the metallization of the film is selected from aluminum, copper, nickel, noble metals such as silver gold, palladium, platinum, iridium, osmium or other corrosion resistant metals such as titanium, niobium, zirconium, hafnium and also, tungsten, molybdenum, or other compounds of metals deposited by chemical vapour deposition such as titanium nitride, silicon carbide, tungsten carbide or films deposited by methane plasma such as diamond like films or graphene.

The selection of solvent may achieve excellent corrosion and barrier properties. The polymer may not be soluble or sensitive to solvents in solvent-based coating compositions.

Example embodiments further include a substrate coated with the corrosion-resistant coating composition and prepared according to example methods, the substrate has improved corrosion resistance of at least 500 hours by the American Society for Testing Materials Standard Practice B117 for Operating Salt Spray (Fog) Apparatus (hereinafter “ASTM B 117”), incorporated by reference herein in its entirety.

Preferably, the substrate has improved corrosion resistance of 500 to 1800 hours by the ASTM B 117 salt spray test.

The substrates that need corrosion protection and coated with the corrosion-resistant composition could be, for example, mild steel, aluminum, copper, silver or wood.

Example methods include manufacturing corrosion-resistant coating compositions with excellent corrosion resistance and barrier properties,

Example processes may include,
a. bi-axially orienting a polymer film to obtain a bi-axially oriented polymeric film having thickness of at least 1μ followed by a vacuum metalizing to obtain an oriented metalized polymer film;
b. shredding the oriented metalized polymer film of step (a) to form the particles having dimension of at least 1×1 mm;
c. selecting a solvent as system or dispersion medium of paint in which the particles of the polymer film of step (b) are not substantially soluble;
d. preparing a paint or a coating composition by using selected solvent of step (c); and
e. dispersing the shredded particles of oriented metalized polymer film of step (b) in the paint which could be a composition suited for a primer, an under coat or a top coat.

The paint as a primer, an under coat or a top coat having a pigment volume concentration in the range of 40%, 30% or 15 to 20%, respectively. The solvent or the dispersion medium is selected from water, mineral turpentine, xylene, toluene, CIX fraction, butanol, butyl acetate, ethanol, ethyl acetate, methyl ethyl ketone, cyclohexanone, methyl iso-butyl ketone, isophorone, mesityl oxide ethylene glycol mono ethyl ether, ethylene glycol mono butyl ether and their acetates, dimethylformamide, dimethylacetamide, sulfolane, dimethylsulfoxide, ethyl lactate, dioxane, tetrahydrofuran, alpha-pinene, delta(3)cerene, longifolin, or solvents from esters, ester alcohol acetates, alcohol propylene glycol ethers, and their acetates.

The paint comprising pigments selected from the group consisting of titanium dioxide, or iron oxide; extenders selected from the group consisting of calcium carbonate, talc, or silica; a film former resin selected from the group consisting of alkyd resin, nitro cellulose, epoxy, polyester, chlorinated rubber, or vinyl resins; or a binder derived from natural vegetable oils or petroleum products.

The paint or coating composition further comprising additives selected from the group consisting of thixotropic agent, associative thickeners and drying agent.

The bi-axial orientation, the metallization or the vacuum metallization, the shredding, the preparing paint/coating formulation of the polymer film is carried out by conventional process.

The selected pigments such as titanium dioxide, iron oxide and extenders such as calcium carbonate, talc, silica are first dispersed and ground to the required finenesses in conventional equipment such as a ball mill, a keddy mill, a sand mill or attritor mill. The mill base is made up with the film former resin such as alkyd resin, nitro cellulose, epoxy, polyester, chlorinated rubber, vinyl resins or any other suitable binder derived from natural vegetable oils or petroleum products. The viscosity of the composition is adjusted by addition of additives for building thixotropy, such as with organically modified clays or associative thickeners, and necessary additives required to assist drying i.e. drying agent. Depending on the thickness of the coating required on the surface, the spreading power of the coating varies from 2 to 5 m²/litre. Accordingly 4 to 10 m² film is added to every liter of the paint in the form of 1×1 mm particles. The thickness of the film decides the weight of the film per unit area. For a polymer with density of 1 g/cc, the weight per m²/micron thickness is 1 gram. Thus if a film of 10 micron is selected, its weight per m² would be 10 g. Thus, for 4 m², 40 g of film particles would be required. For higher spreading rate coating 100 g of 10 micron thick film would be required/liter of the paint.

Thus, in a coating made from chlorinated rubber with 30% pigment volume concentration, which has a spreading rate of 2 m² per litre, 40 g of 10 micron thick polyester film metalized with aluminium 1 mm×1 mm pieces were added per litre. The coating was applied on a primed panel with a brush and the performance of the coating was compared with a panel with same painting system without the added film pieces. The panels were tested for corrosion resistance following the procedure of ASTM B 117. The panel containing film pieces outperformed the standard by more than three times (1500 hours against complete failure at the end of 500 hours)

Example embodiments may be simple yet effective for coatings with excellent corrosion resistance and barrier properties. In application, the area of the film approximately equal to two to three times the surface to be protected is acceptable. Example embodiment coatings may have lower permeability of at least three to four orders of magnitude which reduces the corrosion. This innovation is a very cost effective solution. The glass flakes have high density usually used in conventional techniques to reduce permeability and help in achieving corrosion resistance, but they have limited supply and high cost. Their addition rate is also high due to higher density of glass, such as 2 to 2.2 times more than oriented polymer films. Glass flakes are brittle and need careful handling. These are also very hard and can cause injury to the workmen if adequate care is not exercised while applying the coating. Therefore, example embodiments may be cost effective and user-friendly solutions.

Example embodiments can be illustrated with the below mentioned example but not by way of limitations. Example embodiments may be formulated and rendered by example methods described in the following examples.

### Example 1

A top coat was formulated according to the parameters given in Table 1.

TABLE 1
Top Coat Formulation

| Sr. | | |
|---|---|---|
| No. | Components | Quantity |
| 1 | Chlorinated rubber | 170 g |
| 2 | Titanium dioxide | 100 g |
| 3 | Talc | 80 g |
| 4 | Xylene | 650 ml |

The solid content of the coating was 35%, density was 1.04 to 1.05 kg per litre. It's spreading rate to build a 30μ dry film of thickness was 3.3 m² per litre.

### Example 2

A top coat with anti-corrosion additive namely glass flakes.

A top coat was prepared according to Table 1 having solid content of coating of 35% and density of 1.04 to 1.05 kg per litre. To one litre of this paint, 2% of 10μ thick glass flakes were added. The coating was applied by brush on metal panel.

### Example Method

To one litre of this paint, 52 g of 1 mm×1 mm particles of 7 micron thickness of metalized film were added according to table 2.

TABLE 2
Top Coat Formulation

| Paint | | Metalized film 1 mm × 1 mm particles and |
|---|---|---|
| formulation | Paint | 7 micron thickness |
| A | Top Coat of | 52 g of 1 mm × 1 mm particles of 7 micron |
| | example 1, | thickness of polyethylene terephthalate |
| | 1 litre paint | metalized (100 A thickness) with |
| | | aluminium. |
| B | Top Coat of | 35 g of bi-axially oriented metalized |
| | example 1, | polypropylene film metalized (100 A |
| | 1 litre paint | thickness) with aluminium. |
| C | Top Coat of | 35 g of bi-axially oriented high density |
| | example 1, | polyethylene film metalized (100 A |
| | 1 litre paint | thickness) with aluminium. |
| D | Top Coat of | 35 g of bi-axially oriented high density |
| | example 1, | polyethylene film metalized (100 A |
| | 1 litre paint | thickness) with aluminium |
| E | Top Coat of | 50 g of bi-axially oriented polyamide 6 |
| | example 1, | film metalized (100 A thickness) with |
| | 1 litre paint | aluminium |
| F | Top Coat of | 35 g of bi-axially oriented polyamide 66 |
| | example 1, | film metalized (100 A thickness) with |
| | 1 litre paint | aluminium |

The above-mentioned coatings of the Table 2 were applied by brush on metal panel.

The corrosion test was performed by conducting the salt spray test (ASTM B 117) for Examples 1 and 2. The barrier properties are tested by performing salt spray test. The results of the salt spray and barrier properties are tabulated (Table 3) below:

TABLE 3
Salt spray and barrier properties

| Paint Formulation | Salt spray | Barrier Properties |
|---|---|---|
| Reference | Blisters developed after | Corrosion observed after |
| Example 1 | 100 hours | removal of paint from the |
| | | surface |
| Reference | Blisters developed after | Corrosion observed after |
| Example 2 | 800 hours | removal of paint from the |
| | | surface |
| A | Blisters not developed till | Slight corrosion observed |
| | 500 hours | after removal of paint |
| | | from the surface |
| B | No blisters observed till | Clean metal surface found |
| | 1500 hrs | on removal of the coating. |
| C | No blisters observed till | Clean metal surface found |
| | 1000 hrs | on removal of the coating. |
| D | No blisters observed till | Clean metal surface found |
| | 1000 hrs | on removal of the coating. |
| E | No blisters observed till | Clean metal surface found |
| | 1200 hrs | on removal of the coating. |
| F | No blisters observed till | Clean metal surface found |
| | 1200 hrs | on removal of the coating. |

The coated panel were subjected to salt spray test for 1500 hours to compare the performance of example embodiment coatings of reference example 1 and 2. According to the results, blisters are developed in the coating of reference example 1 after 400 hours and in the coating of reference example 2 after 800 hours. This represents a 3-fold improvement. Development of blisters are indication of corrosion and hence failure of the coating.

Example embodiments may eliminate corrosion and associated problems with metalized bi-axially oriented films thereby providing surface coating with excellent corrosion resistance, barrier properties, etc. by reducing water and oxygen permeability.

Example embodiment coatings may be uniform and efficient with particles of oriented metalized film that is not soluble or swollen or shrivelled in the solvent system of the composition. Example methods create example embodiment coating compositions that allow for coating a surface of the substrate with improved corrosion resistance, barrier properties, etc. by reducing water and oxygen, hydrogen sulphide, and carbon dioxide permeability.

Example embodiments and methods thus being described, it will be appreciated by one skilled in the art that example embodiments may be varied and substituted through routine experimentation while still falling within the scope of the following claims. For example, although some substrates are used in examples, it is understood that any substrate are useable in example embodiments—and fall within the scope of the claims. Such variations are not to be regarded as departure from the scope of these claims.

1. A corrosion-resistant coating composition comprising:
a paint or a lacquer; and
at least 0.1% particles of a bi-axially oriented metalized polymer film, wherein the film is not soluble in a solvent or a dispersion medium of the paint or the lacquer.

2. The composition of claim 1, wherein the particles of the film are up to 10% of the composition.

3. The composition of claim 1, wherein the thickness of the film is at least 1μ.

4. The composition of claim 1, wherein the thickness of the film is in the range of about 1μ to about 200μ.

5. The composition of claim 4, wherein the thickness of the film is in the range of about 1μ to about 5μ.

6. The composition of claim 4, wherein the particles of the film have dimensions of at least 1×1 mm.

7. The composition of claim 1, wherein the polymer of the film is at least one of,
polyethylene terephthalate,
aliphatic or aromatic polyamides,
aliphatic or aromatic polyimides,
polysulfones,
polypropylene,
high, low, or medium density polyethylene,
linear low-density polyethylene,
polystyrene,
polyvinyl chloride,
polyvinylidene chloride,
PVDF, and
PTFE.

8. The composition of claim 1, wherein the polymer of the film is bi-axially oriented and further metalized with vacuum or electro deposition or electroless coating.

9. The composition of claim 1, wherein the metal of the film is at least one of,
aluminium,
copper,
nickel,
silver,
gold,
palladium,
platinum,
iridium,
titanium,
niobium,
zirconium,
hafnium or molybdenum,
titanium nitride, silicon carbide, or tungsten carbide, and
diamond or graphene.

10. The composition of claim 1, wherein the solvent or the dispersion medium is at least one of,
water,
mineral turpentine,
xylene,
toluene,
CIX fraction,
butanol,
butyl acetate,
ethanol,
ethyl acetate,
methyl ethyl ketone,
cyclohexanone,
methyl iso-butyl ketone,
isophorone,
mesityl oxide ethylene glycol mono ethyl ether, ethylene glycol mono butyl ether, and acetates of mesityl oxide ethylene glycol mono ethyl ether and ethylene glycol mono butyl ether,
dimethylformamide,
dimethylacetamide,
sulfolane,
dimethylsulfoxide,
ethyl lactate,
dioxane,
tetrahydrofuran,
alpha-pinene,
delta(3)cerene,
longifolin or solvents from esters, and
ester alcohol acetates, alcohol propylene glycol ethers, and acetates of ester alcohol acetates and alcohol propylene glycol ethers.

11. A method manufacturing corrosion-resistant coating composition having a paint or a lacquer and at least 0.1% particles of a bi-axially oriented metalized polymer film, the film not being soluble in a solvent or a dispersion medium of the paint or the lacquer, the method comprising:
bi-axially orienting a polymer film to obtain a bi-axially oriented polymeric film having thickness of at least 1μ followed by a vacuum metalizing to obtain a bi-axially oriented metalized polymer film;
shredding the bi-axially oriented metalized polymer film to form the particles to at least 1×1 mm;
selecting a solvent as system or a dispersion medium of paint in which the particles of the polymer film is not substantially soluble;
preparing a paint or a coating composition by using selected solvent; and
dispersing the shredded particles of oriented metalized polymer film in the paint as a primer, an under coat, or a top coat.

12. The method of claim 11, wherein the paint as the primer has a pigment volume concentration of about 40%, the paint as the under coat has a pigment volume concentration of about 30%, and the paint as the top coat has a pigment volume concentration of about 15% to about 20%.

13. The method of claim 12, wherein the pigments include at least one of,
titanium dioxide or iron oxide,
calcium carbonate, talc, or silica extenders,
a film former resin of alkyd resin, nitro cellulose, epoxy, polyester, chlorinated rubber, or vinyl resins, and
a binder derived from natural vegetable oils or petroleum products.

14. The method of claim 11, wherein the solvent or the dispersion medium is at least one of,
water,
mineral turpentine,
xylene,
toluene,
CIX fraction,
butanol,
butyl acetate,
ethanol,
ethyl acetate,
methyl ethyl ketone,
cyclohexanone,
methyl iso-butyl ketone,
isophorone,
mesityl oxide ethylene glycol mono ethyl ether, ethylene glycol mono butyl ether, and acetates of mesityl oxide ethylene glycol mono ethyl ether and ethylene glycol mono butyl ether,
dimethylformamide,
dimethylacetamide,
sulfolane,
dimethylsulfoxide,
ethyl lactate,
dioxane,
tetrahydrofuran,
alpha-pinene,
delta(3)cerene,
longifolin or solvents from esters, and
ester alcohol acetates, alcohol propylene glycol ethers, and acetates of ester alcohol acetates and alcohol propylene glycol ethers.

15. The method of claim 11, wherein the paint or coating composition includes additives of a thixotropic agent, associative thickeners and/or a drying agent.

16. A coated substrate comprising:
the substrate;
a paint or a lacquer; and
at least 0.1% particles of a bi-axially oriented metalized polymer film, wherein the film is not soluble in a solvent or a dispersion medium of the paint or the lacquer, wherein the substrate has corrosion resistance of at least 500 hours by the ASTM B 117 salt spray test.

17. The substrate of claim 16, wherein the substrate is at least one of mild steel, aluminium, copper, silver, and wood.
